(19) United States
(12) Patent Application Publication
(10) Pub. No.: US 2022/0243871 A1
(43) Pub. Date: Aug. 4, 2022

(54) TANK FOR STORING LIQUID HYDROGEN AND METHOD OF USE

(71) Applicant: CRYOGENIC FUELS INC., Sumerduck, VA (US)

(72) Inventor: Roy E. ADKINS, Catlett, VA (US)

(21) Appl. No.: 17/579,822

(22) Filed: Jan. 20, 2022

Related U.S. Application Data
(60) Provisional application No. 63/143,219, filed on Jan. 29, 2021.

(51) Int. Cl. F17C 3/08

(52) U.S. Cl. CPC F17C 3/08; F17C 2203/012; F17C 2203/0395; F17C 2201/0109; F17C 2223/0161; F17C 2203/0629; F17C 2221/012

(57) ABSTRACT

A method of storing liquid hydrogen employs a tank with inner and outer shells. A support beam with its ends supported in endwalls of the outer shell extends through a central sleeve in the inner shell. Raised formations on the support beam engage the interior of the sleeve to support the inner shell within the outer shell. The sealed space formed between the shells inhibits heat conduction into the liquid hydrogen held in the inner shell. Pins extending transversely through the support beam prevent turning of the support beam in its endwall supports and turning of inner shell about the support beam. Getter material and radiation shielding placed about the support beam within the sleeve of the inner shell afford additional impediments to heat transfer into the inner shell.

This application claims priority under 35 USC § 119(e) to application No. 63/143,219, which was filed on Jan. 29, 2021 and is hereby incorporated in its entirety by reference.

### FIELD OF THE INVENTION

Particularly, the present invention is directed to a vehicle-mounted tank for receiving and holding liquid hydrogen. The hydrogen intended for transfer by the apparatus and method of this invention exist in a cryogenic state. The present invention is particularly adapted for, but not limited to, a vehicle-mounted tank for efficiently holding the liquid hydrogen.

### BACKGROUND ART

It is known to store liquified natural gas and, typically, LNG vehicle fuel tanks are of double wall construction. The inner shell, a pressure vessel containing LNG fuel, is supported within the outer shell. Radiation shielding, such as wraps of polyester sheet aluminized on both sides, is placed in the space between the inner and outer shells, and the space is placed under a high vacuum to provide particularly effective insulation between the inner shell and the ambient. Since LNG is a cryogenic fuel that boils at −258° F. (at normal atmospheric pressure), the pressure vessel support structure must exhibit a very low conductive heat leak. This low heat leak minimizes tank pressure build-up during vehicle non-operational time periods and prevents venting of fuel during a designed “no vent” standby time. The pressure vessel support structure must also be designed to withstand vehicle over-the-road vibration and repeated high shock impact loading on all axes. The support structure must accommodate this high dynamic loading over the life of the vehicle without cyclic fatigue or material creep failure.

To the extent necessary, the entire disclosure of U.S. Pat. No. 5,353,849, which issued to Harold E. Sutton and Roy E. Adkins, is hereby incorporated by reference.

With the increased emphasis on clean burning fuels, e.g., liquid hydrogen, a need exists to provide improved ways to store liquid hydrogen for later use as a fuel. The invention responds to this need by providing a storage tank that is suitable for storing liquid hydrogen.

### SUMMARY OF THE INVENTION

The invention is an improvement in the use of the tank assembly disclosed in U.S. Pat. No. 6,880,719 to Sutton et al. This tank assembly is described in connection with storing liquefied natural gas (LNG).

However, it has been realized that although storing liquid hydrogen presents a different set of problems as compared to storing LNG, the tank assembly disclosed in the '719 patent is believed to be suitable for storing liquid hydrogen for later use of the hydrogen as a fuel source.

Thus, the invention relates to a method of providing the tank assembly of the '719 patent and filling it with liquid hydrogen for later use of the hydrogen as a fuel.

More particularly, the inventive method of storing liquid hydrogen in a tank assembly includes providing a tank assembly, wherein the tank assembly includes an inner shell including a first shell body extending between first and second endwalls and a sleeve extending along a longitudinal axis between the first and second endwalls to form, with the first shell body and the first and second endwalls, a generally annular space for holding the hydrogen cryogenically. The tank assembly also includes an outer shell including a second shell body extending between third and fourth endwalls, the outer shell being disposed about the inner shell to form a sealed space between the two shells which inhibits the transfer of heat from the outer shell to the inner shell. A support beam is also part of the tank assembly, the support beam supported by and extending between the third and fourth endwalls and through the sleeve to provide support for the inner shell within the outer shell. The tank assembly also includes a pair of raised formations on the support beam fitting closely within the sleeve for engaging the interior of the sleeve while minimizing heat transfer between the support beam and the sleeve, the raised formations being spaced form each other and from the ends of the support beam, and a pin extending transversely through the sleeve and through one of the raised formations for inhibiting turning of the two shells with respect to each other about the longitudinal axis. To complete the method, the tank assembly is filled with liquid hydrogen.

The tank assembly can also include getter material disposed between the sleeve and the support beam and between the raised formations for inhibiting gas heat conduction between the support beam and the sleeve and an example of the getter material is activated charcoal.

The tank assembly can also include radiation shielding disposed between the sleeve and the support beam and between the raised formations and the ends of the support beam. The radiation shielding can include spaced layers of aluminized sheet material.

The invention also includes an alternative method of storing liquid hydrogen in a tank assembly similar to that described above. However, wherein the tank assembly described above has a pair of raised formations and a pin, the alternative method uses a tank assembly that has at least one raised formation on the support beam fitting closely within the sleeve for engaging the interior of the sleeve while minimizing heat transfer between the support beam and the sleeve and means for inhibiting turning of the two shells with respect to each other about the longitudinal axis, the means for inhibiting turning comprising a pin extending transversely through the sleeve and through the raised formation. As with the first method described, the tank assembly is then filled with liquid hydrogen.

The invention also includes the product of the methods described above, which is a liquid hydrogen-filled tank assembly with the tank assembly like those described above.

### BRIEF DESCRIPTION OF THE DRAWINGS

FIG. 1 is a cross-sectional illustration of a preferred tank construction;

FIG. 2 is a cross-sectional illustration showing details of the support beam used in the tank shown in FIG. 1; and

FIG. 3 is a cross-sectional illustration showing details of a lock pin used in the support beam shown in FIG. 2

### DETAILED DESCRIPTION OF THE INVENTION

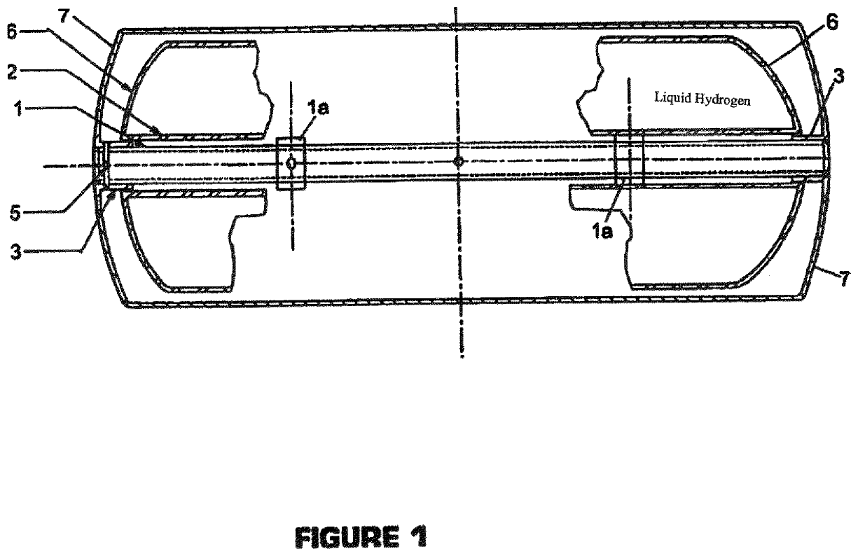

A preferred tank construction is shown in FIGS. 1-3. While this tank construction has been designed for storage of LNG, the tank is also suitable for storing liquid hydrogen.

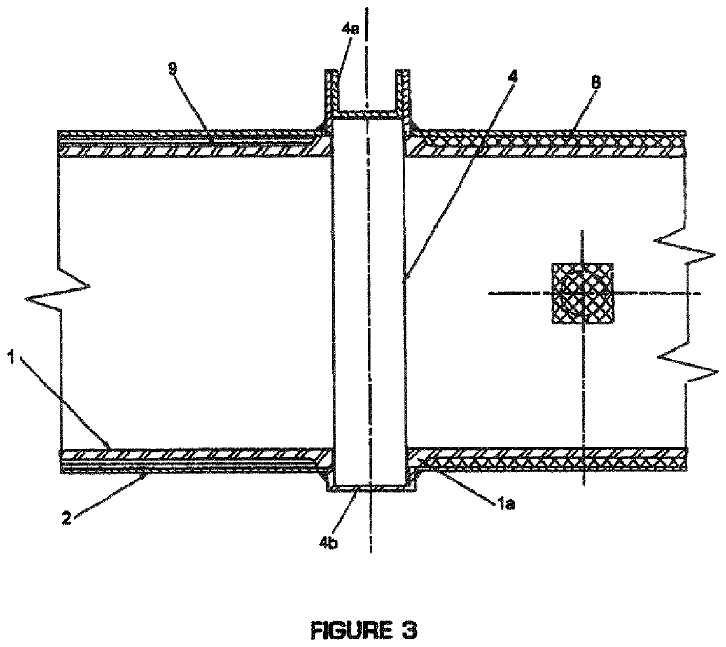

The tank construction comprises a hollow beam 1 fabricated from high strength low thermal conductivity material such as Grade 11 fiberglass that is compatible with LNG. The beam is contained within a pressure vessel support tube 2 which bears against beam collars la formed integrally with the beam. The support tube 2 is welded at each end into the pressure vessel heads 6. The beam is supported at both ends by insertion into socket supports 3 that are welded to the inside of the outer shell heads 7. The transverse pressure vessel loads are borne by the beam 1 in bending and vertical shear and transmitted to the socket supports 3. The applied longitudinal tank loads are borne by a lock pin 4 inserted transversely through the beam 1 and pressure vessel support pipe 2, as best shown in FIG. 3. Pin 4 is contained in a transverse sleeve welded into the support pipe. To maintain vacuum integrity, the ends of the sleeves are sealed by welded closure fittings 4a, 4b. Pin 4 also receives pressure vessel rotational (torsional) loads and transmits these loads to an outer shell socket support 3 via beam 1 and another pin 5 fastened to the socket and extending transversely through an end of the beam.

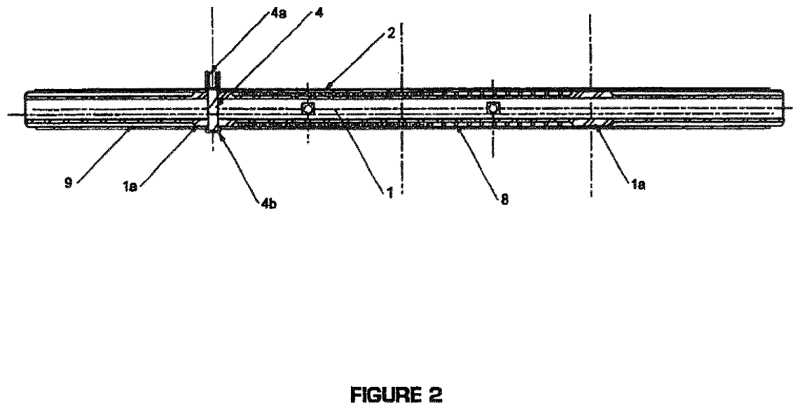

As an aid to retaining the vacuum between the inner and outer tank shells, a getter 8, such as activated charcoal is placed into the annular space between the pressure vessel support tube 2 and beam 1 between load support collars la, as best shown in FIGS. 2 and 3. The getter absorbs moisture and hydrocarbons to inhibit gas heat conduction through migration of molecules. The space between the tube 2 and the beam 1 between load support collars la provides a favorable location for the getter which affords good contact of the getter with the cold pressure vessel support tube 2 to thus ensure getter efficiency. Also, an appropriate molecular sieve material (such as silver zeolite) is placed within the vacuum annulus between the pressure vessel head 6 and outer shell head 7.

To minimize radiant heat transfer from the beam into the liquid hydrogen, which surrounds the pressure vessel support tube, alternating layers of radiation shielding 9 and a spacer material are disposed in the annular space between the beam 1 and tube 2 at each end of the beam. Polyester sheet aluminized on both sides can serve as a suitable radiation shield, and nylon netting can serve as the spacer. Preferably, several wraps of the radiation shield and intervening spacer are located between the tube 2 and beam 1 in the space extending from the beam collars la to the socket supports 3 at each end of the tank. The inside of the beam is filled with radiation shielding, aluminized polyester sheet, to prevent trapping radiation in a “black hole.”

The pressure vessel support beam can be configured for any tank size and configuration to accommodate very high vehicle cyclic dynamic loading as induced by typical over-the-road operation. The proper detail design/sizing will ensure no fatigue or material creep failure for the life of the vehicle. The support beam design is capable of carrying repetitive high shock impact loads along all axes while exhibiting a very low conductive heat leak.

As an example, when the tank uses LNG, a cylindrical 26-inch diameter fuel tank, containing 100 gal. of LNG, can exhibit a total tank heat leak (in a 90° F. temperature environment) of 11 Btu/hr using the described pressure vessel support beam. This thermal performance is based on a superinsulated tank using multi-layer radiation shielding in a high 10⁻5 to 10⁻⁶ mmHg vacuum range. The conductive heat leak of the pressure vessel support beam is 1.4 Btu/hr, which is less than 13% of the total tank heat leak. It is expected that the same type of conductive heat leak performance would occur if the tank is used to store hydrogen cryogenically.

In terms of the method of storing liquid hydrogen, a tank assembly is provided that has an inner shell including a first shell body extending between first and second endwalls and a sleeve extending along a longitudinal axis between the first and second endwalls to form, with the first shell body and the first and second endwalls, a generally annular space for holding the hydrogen cryogenically. An outer shell is also provided and includes a second shell body extending between third and fourth endwalls, the outer shell being disposed about the inner shell to form a sealed space between the two shells which inhibits the transfer of heat from the outer shell to the inner shell.

The tank assembly also includes a support beam supported by and extending between the third and fourth endwalls and through the sleeve to provide support for the inner shell within the outer shell. A pair of raised formations on the support beam fit closely within the sleeve for engaging the interior of the sleeve while minimizing heat transfer between the support beam and the sleeve, the raised formations being spaced form each other and from the ends of the support beam.

The tank assembly also includes a pin extending transversely through the sleeve and through one of the raised formations for inhibiting turning of the two shells with respect to each other about the longitudinal axis.

Once the tank assembly is made available, it can be filled with liquid hydrogen. The filling could be done in similar circumstances and conditions as when filling the tank with LNG. Since these methods of filling are well known in the art, a further description of the details of such filling methods is not required for understanding of the invention.

As such, an invention has been disclosed in terms of preferred embodiments thereof which fulfills each and every one of the objects of the present invention as set forth above and provides a new and improved method for storing liquid hydrogen.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A method of storing liquid hydrogen in a tank assembly comprising:
a) providing a tank assembly comprising:
an inner shell including a first shell body extending between first and second endwalls and a sleeve extending along a longitudinal axis between the first and second endwalls to form, with the first shell body and the first and second endwalls, a generally annular space for holding the hydrogen cryogenically;
an outer shell including a second shell body extending between third and fourth endwalls, the outer shell being disposed about the inner shell to form a sealed space between the two shells which inhibits the transfer of heat from the outer shell to the inner shell;
a support beam supported by and extending between the third and fourth endwalls and through the sleeve to provide support for the inner shell within the outer shell; a pair of raised formations on the support beam fitting closely within the sleeve for engaging the interior of the sleeve while minimizing heat transfer between the support beam and the sleeve, the raised formations being spaced form each other and from the ends of the support beam; and
a pin extending transversely through the sleeve and through one of the raised formations for inhibiting turning of the two shells with respect to each other about the longitudinal axis; and
b) filling the tank assembly with liquid hydrogen.

2. The method as recited in claim 1, wherein the tank assembly further comprises getter material disposed between the sleeve and the support beam and between the raised formations for inhibiting gas heat conduction between the support beam and the sleeve.

3. The method as recited in claim 2, wherein the getter material comprises activated charcoal.

4. The method as recited in claim 1, wherein the tank assembly further comprises radiation shielding disposed between the sleeve and the support beam and between the raised formations and the ends of the support beam.

5. The method as recited in claim 4, wherein the radiation shielding comprises spaced layers of aluminized sheet material.

6. A method of storing liquid hydrogen in a tank assembly comprising:
a) providing a tank assembly comprising:
an inner shell including a first shell body extending between first and second endwalls and a sleeve extending along a longitudinal axis between the first and second endwalls to form, with the first shell body and the first and second endwalls, a generally annular space for holding the liquid hydrogen;
an outer shell: including a second shell body extending between third and fourth endwalls, the outer shell being disposed about the inner shell to form a sealed space between the two shells which inhibits the transfer of heat from the outer shell to the inner shell;
a support beam supported by and extending between the third and fourth endwalls and through the sleeve to provide support for the inner shell within the outer shell; at least one raised formation on the support beam fitting closely within the sleeve for engaging the interior of the sleeve while minimizing heat transfer between the support beam and the sleeve; and
means for inhibiting turning of the two shells with respect to each other about the longitudinal axis, the means for inhibiting turning comprising a pin extending transversely through the sleeve and through the raised formation; and
b) filling the tank assembly with liquid hydrogen.

7. A liquid hydrogen-containing tank assembly comprising:
a tank assembly comprising:
an inner shell including a first shell body extending between first and second endwalls and a sleeve extending along a longitudinal axis between the first and second endwalls to form, with the first shell body and the first and second endwalls, a generally annular space for holding the hydrogen cryogenically;
an outer shell including a second shell body extending between third and fourth endwalls, the outer shell being disposed about the inner shell to form a sealed space between the two shells which inhibits the transfer of heat from the outer shell to the inner shell;
a support beam supported by and extending between the third and fourth endwalls and through the sleeve to provide support for the inner shell within the outer shell; a pair of raised formations on the support beam fitting closely within the sleeve for engaging the interior of the sleeve while minimizing heat transfer between the support beam and the sleeve, the raised formations being spaced form each other and from the ends of the support beam; and
a pin extending transversely through the sleeve and through one of the raised formations for inhibiting turning of the two shells with respect to each other about the longitudinal axis; and
a quantity of liquid hydrogen filling the tank assembly.
